(19) United States
(12) Patent Application Publication
(10) Pub. No.: US 2024/0408785 A1
(43) Pub. Date: Dec. 12, 2024

(54) CUTTING DEVICE AND DRIVE WHEEL

(71) Applicant: Prinz GmbH, Loosdorf (AT)

(72) Inventor: Ingo FREITHOFNIGG, Loosdorf (AT)

(21) Appl. No.: 18/565,462

(22) PCT Filed: Jun. 7, 2022
(86) PCT No.: PCT/AT2022/060186

§ 371 Date: Nov. 29, 2023

(30) Foreign Application Priority Data
Jun. 8, 2021 (AT) A50461/2021

(51) Int. Cl. B27B 17/08; F16H 55/30

(52) U.S. Cl. CPC B27B 17/08; F16H 55/30

(57) ABSTRACT

The invention relates to a cutting device (12) and a related drive wheel (11), wherein the cutting device (12) comprises a saw chain (13) and a drive wheel (11), wherein the tie straps (17) are arranged alongside the drive links (16), wherein the tie straps (17) are connected to the drive links (16) by connecting means (18), wherein cutting devices (12) for cutting an item or material are provided on the drive links (16) and/or tie straps (17), wherein the drive wheel (11) has a plurality of drive-link receptacles (6), wherein part of the respective drive links (16) is in engagement with the respective drive-link receptacle (6), wherein the drive wheel (11) has a plurality of link receptacles of a first type (2), wherein the link receptacles of the first type (2) are in the form of elevations, wherein the link receptacles of the first type (2) are in engagement with the respective tie straps (17), and wherein the link receptacles of the first type (2) are designed to transmit force from the drive wheel (11) to the respective tie straps (17).

The invention relates to a cutting device, in particular a chainsaw, and a respective drive wheel according to the preambles of the independent patent claims.

A large number of chainsaws with drive wheels for saw chains are known from the state of the art. For example, chainsaws are known in which only the driving link is driven by the drive wheel. However, the disadvantage of such cutting devices is that the saw chain oscillates perpendicular to the running direction during the switch-on process and during the cutting process. This oscillation may cause the saw chain to move forwards and backwards, which elongates the saw chain and reduces its working life.

The object of the invention is to overcome the disadvantages of the state of the art. In particular, it is the object of the invention to provide a cutting device in which the working life of the saw chain is extended. Among others, the object of the invention is to provide a cutting device in which the forward and backward movements of the saw chain are prevented and/or reduced and the cutting process is smoother as a result. Further tasks of the invention include providing such a drive wheel for a cutting device.

In particular, the object according to the invention is solved by the features of the independent patent claims.

The invention relates in particular to a cutting device, in particular a chainsaw, comprising a saw chain and a drive wheel.

It is preferably provided that the saw chain comprises driving links and connecting links.

Preferably, it is provided that the connecting links are connected to the driving links by connecting means, in particular rivets.

Preferably, it is provided that cutting devices for cutting a material to be cut, in particular for chipping wood or plastic, are provided on the driving links and/or connecting links.

Preferably, it is provided that the drive wheel has a plurality of driving link mounts, wherein optionally a part of the respective driving link is in engagement with the respective driving link mount, so that force can be transmitted from the drive wheel to the driving links.

Preferably, it is provided that the drive wheel has a plurality of link mounts of the first type.

Preferably, it is provided that the link mounts of the first type are designed as projections, in particular as raised teeth.

Preferably, it is provided that the link mounts of the first type engage with the respective connecting links, in particular in a form-fitting manner.

Preferably, it is provided that the link mounts of the first type are arranged to transmit force from the drive wheel to the respective connecting links.

Preferably, it is provided that the link mounts of the first type are designed to move the connecting links in the running direction of the saw chain so that the saw chain can be driven.

The saw chain may be designed as an endless chain. The saw chain may be designed as a 2-link chain or a 3-link chain.

Preferably, the connecting links are arranged next to and/or overlapping the driving links, in particular on both sides.

The saw chain may be designed to remove material from the material to be processed.

Optionally, it is provided that the driving link mounts are designed to accommodate at least part of the respective driving links, in particular in a form-fitting manner.

Optionally, force may be transmitted from the drive wheel to the saw chain through the driving link mounts and/or the link mount of the first type.

Preferably, it is provided that the driving link mounts are designed as projections, in particular as raised teeth.

Optionally, it is provided that the link mount of the first type is designed to receive at least a part of the respective connecting link.

Optionally, it is provided that the link mount of the first type projects beyond the lower edge of the respective connecting link in engagement with the drive wheel.

The link mount of the first type may extend in the direction of the respective connecting means of the respective connecting link.

The link mount of the first type may extend beyond the lower edge of the respective connecting link in the direction of the respective connecting means when the respective connecting link is engaged with the link mount of the first type.

Optionally, it is provided that the link mount of the first type extends into the connecting link. In particular, the link mount of the first type may extend into the respective connecting link standing with the drive wheel.

A nest for the saw chain, in particular for the driving links and connecting links, may be formed on the drive wheel by the link mounts of the first type designed as projections, whereby the saw chain may be fixable and/or retainable during force transmission. In other words, forward and backward movements of the saw chain may be prevented and/or reduced by the design of the drive wheel according to the invention, in particular by this so-called nest.

Optionally, it is provided that a first contact surface is formed between the saw chain, in particular the driving links, and the drive wheel by the driving link mounts.

Optionally, it is provided that at least one additional contact surface is formed between the saw chain, in particular the driving links, and the drive wheel by the first type of link mount. This allows the force to be transmitted to be distributed and thus the load on the connecting means to be reduced.

In the context of the present invention, in particular during force transmission, at least a part of the saw chain may be in engagement with the drive wheel. As a result, the respective driving links may also be in engagement with the respective driving link mounts, and the respective connecting links may be in engagement with the respective link mounts.

In other words, during the movement of the saw chain, a part of the saw chain may be in engagement with the drive wheel. Thus, the driving links associated with this part of the saw chain may also be in engagement with the driving link mounts and connecting links may be in engagement with the connecting link mounts.

A part of the saw chain, in particular at least one driving link and/or at least one connecting link, may be in contact with the drive wheel, in particular with at least one driving link mount and/or at least one connecting link mount.

Part of the saw chain, in particular at least one driving link and/or at least one connecting link, may be in engagement with the drive wheel, in particular with at least one driving link mount and/or at least one connecting link mount.

Optionally, it is provided that the driving link mount is in engagement, in particular exclusively, with the respective driving links.

Optionally, it is provided that the link mount of the first type engages, in particular exclusively, with the respective connecting links.

Optionally, it is provided that the link mounts of the first type engage with a first region, in particular with a peripheral region, of the outer edge of the respective connecting link during force transmission.

Optionally, it is provided that the link mount of the first type engages with the rear edge of the respective connecting link.

Optionally, it is provided that the link mount of the first type engages with the respective connecting link in a toothed wheel-like manner.

Optionally, it is provided that the link mount of the first type rests against the outer edge, in particular the lower edge, of the respective connecting link when engaging with the respective connecting link.

Optionally, it is provided that the link mount of the second type engages, in particular exclusively, with the respective connecting links.

Optionally, it is provided that several link mounts of the second type are provided on the drive wheel.

Optionally, it is provided that the link mounts of the second type are designed as projections, in particular as raised teeth.

Optionally, it is provided that the link mounts of the second type engage with the respective connecting links, in particular in a form-fitting manner.

Optionally, it is provided that the link mounts of the second type are designed to move the connecting links in the running direction of the saw chain so that the saw chain can be driven.

Optionally, it is provided that the link mount of the second type is designed to receive at least a part of the respective connecting link.

A nest for the saw chain, in particular for the connecting links, may be formed on the drive wheel by the link mounts of the first and second type, designed as projections, whereby the saw chain may be fixable and/or retainable during force transmission.

In other words, forward and backward movements of the saw chain may be prevented and/or reduced by the design of the drive wheel according to the invention, in particular by this so-called nest.

Optionally, the height of the link mounts of the first type is greater than the height of the link mounts of the second type.

Optionally, it is provided that the link mount of the second type engages on the outer edge, in particular at a distance from the first region, of the respective connecting link.

Optionally, it is provided that the link mount of the second type engages on the outer edge, in particular the lower edge, of the respective connecting link when engaging with the respective connecting link.

The link mount of the first type may extend in the direction of the respective connecting means of the respective connecting link.

In particular, the link mounts of the first type extend further in the direction of the respective connecting means of the respective connecting link than the link mounts of the second type.

In particular, the link mounts of the first type project further beyond the lower edge of the respective connecting links than the link mounts of the second type.

Optionally, the link mounts of the first type are designed differently from the link mounts of the second type.

In particular, the link mounts of the first type have different projections, in particular teeth, than the link mounts of the second type.

Optionally, it is provided that the link mounts of the second type are arranged on the drive wheel in such a way that they engage with a second area of the outer edge of the respective connecting link during force transmission.

Optionally, it is provided that the link mounts of the second type are arranged on the drive wheel in such a way that they engage in the centre of the respective connecting link during force transmission.

In particular, it is provided that the link mount of the first type and the link mount of the second type are arranged in such a way that they are in engagement with the respective connecting link at a distance from one another.

Optionally, it is provided that the link mounts of the second type are arranged between the link mounts of the first type on the drive wheel.

Optionally, it is provided that the link mounts of the first type and/or the link mounts of the second type engage with two different areas of the respective connecting links.

In particular, the link mounts of the first type and/or the link mounts of the second type may engage with two different regions of the respective connecting links.

Optionally, the drive wheel comprises a driving link disc and two link mounting discs.

Optionally, it is provided that the three discs, in particular the driving link disc and the link mounting discs, are arranged concentrically to one another.

Optionally, it is provided that the driving link mounts are provided on the centrally arranged disc of the drive wheel, in particular the driving link disc.

Optionally, it is provided that the link mounting discs are arranged on the driving link disc, in particular on both sides.

Optionally, the link mounts of the first type and optionally the link mounts of the second type are provided on the link mounting discs.

In particular, it may be provided that driving link mounts are arranged, in particular exclusively on the driving link disc.

In particular, it may be provided that link mounts of the first type and optionally link mounts of the second type are arranged, in particular exclusively, on the link mounting discs.

Optionally, it is provided that the link mounts of the first type are provided, in particular exclusively, on the link mounting discs.

Optionally, it is provided that the link mounts of the first type and the link mounts of the second type are provided on the link mounting discs, in particular exclusively.

Optionally, it is provided that the link mounting discs project at least partially beyond the driving link disc.

In particular, the link mounting discs may be arranged to laterally delimit the driving link mount.

The driving link disc may be arranged in the centre of the link mounting discs. Furthermore, the link mounting discs may be arranged on the right and left sides of the driving link disc.

Optionally, the driving link mounts are laterally limited by the arrangement of the link mounting discs on the driving link disc.

Optionally, the drive wheel may also comprise two guide discs.

Optionally, it is provided that the guide discs are arranged concentrically to the driving link disc and the link mounting discs of the drive wheel.

Optionally, it is provided that the guide discs are designed to guide the saw chain, in particular horizontally.

Optionally, it is provided that the guide discs are arranged on the three discs, in particular on both sides.

Optionally, it is provided that the guide discs project at least partially beyond the driving link disc and/or the link mounting discs.

In particular, the guide discs may be arranged to laterally delimit the link mounting discs.

The driving link disc may be arranged in the centre of the link mounting discs and the guide discs. Furthermore, the guide discs may be arranged on the free side of the link mounting disc.

Optionally, the link mounts of the first type and/or the link mounts of the second type are laterally limited by the arrangement of the guide discs on the link mounting discs.

Optionally, it is provided that the guide discs have connecting means recesses for guiding the connecting means.

Optionally, it is provided that the connecting means recesses are designed to transmit force from the drive wheel to the saw chain, in particular to the connecting means.

Optionally, it is provided that the driving link disc is connected, in particular welded, to the drive device of the cutting device.

Optionally, it is provided that the other discs, in particular the link mounting discs and/or the guide discs, are connected to the driving link disc, in particular to the drive device, preferably exclusively, via connecting devices, in particular screws.

In particular, it may be provided that the link mounting discs and the guide discs are connected to the drive device, in particular exclusively, via the driving link disc.

Optionally, it is provided that, in particular exclusively, the driving link disc is connected to the drive device.

Optionally, it is provided that, in particular exclusively, the driving link disc is driven by a drive device.

Optionally, it is provided that the driving link mounts are provided, in particular evenly distributed, on the circumference of the drive wheel, in particular of the driving link disc.

Optionally, it is provided that the link mounts of the first type are provided, in particular evenly distributed, on the circumference of the drive wheel, in particular the link mounting discs.

Optionally, it is provided that the link mounts of the second type are provided, in particular evenly distributed, on the circumference of the drive wheel, in particular the link mounting discs.

Optionally, it is provided that the driving link mounts are arranged symmetrically on the drive wheel, in particular the driving link disc.

Optionally, it is provided that the link mounts of the first type are arranged symmetrically on the drive wheel, in particular the link mounting discs.

Optionally, it is provided that the link mounts of the second type are arranged symmetrically on the drive wheel, in particular the link mounting discs.

Optionally, it is provided that the driving link mounts are arranged evenly spaced from one another on the drive wheel, in particular the driving link disc.

Optionally, it is provided that the link mounts of the first type are arranged evenly spaced apart from one another on the drive wheel, in particular the link mounting discs.

Optionally, it is provided that the link mounts of the second type are arranged evenly spaced apart from one another on the drive wheel, in particular the link mounting discs.

The driving link disc and/or the link mounting disc may be designed as a toothed wheel, a toothed wheel-like disc, a profiled disc and/or a wheel-like disc.

The driving link disc, in particular the driving link mounts, may correspond to the driving links, in particular the profiles of the driving links.

The link mounting discs, in particular the link mounts of the first type and optionally the link mounts of the second type, may correspond to the connecting links, in particular the profiles of the connecting links.

Optionally, it is provided that the driving link mounts on the driving link disc are arranged corresponding to the link mounts of the second type on the link mounting discs, in particular evenly distributed.

Optionally, it is provided that the arrangement of the driving link mounts on the driving link disc corresponds to the arrangement of the link mounts of the second type on the link mounting discs.

In particular, it may be provided that the link mounting discs are arranged on the driving link disc in such a way that the link mounts of the second type are arranged and/or abut the driving link mounts on both sides, in particular directly.

In particular, the link mounts of the second type may abut and/or adjoin the side surfaces of the driving link mounts, in particular directly.

Optionally, it is provided that the driving link mounts project beyond the link mounts of the second type.

Optionally, it is provided that the link mounting discs are arranged on the driving link disc in such a way that the link mounts of the first type are arranged at a distance from the driving link mounts.

Optionally, it is provided that the link mounts of the first type project beyond the driving link mounts.

Optionally, it is provided that the driving link mounts each have a driving link thrust surface.

Optionally, it is provided that the driving link thrust surface is arranged to transmit force to the driving link.

Optionally, it is provided that the link mount of the first type has a respective link thrust surface of the first type.

Optionally, it is provided that the link thrust surface of the first type is designed to transmit force to the respective connecting link.

Optionally, it is provided that the link mount of the second type has a link thrust surface of the second type.

Optionally, it is provided that the link thrust surface of the second type is arranged to transmit force to the respective connecting link.

Optionally, it is provided that the driving link thrust surface forms a first contact surface for transmitting force from the drive wheel to the saw chain, in particular the driving links.

Optionally, it is provided that the link thrust surfaces of the first type form two further contact surfaces for transmitting force from the drive wheel to the saw chain, in particular the connecting links.

Optionally, it is provided that the link thrust surfaces of the second type form two further contact surfaces for transmitting force from the drive wheel to the saw chain, in particular the connecting links.

Optionally, it is provided that four further contact surfaces are formed by the link mounting discs, in particular the link thrust surfaces, which are designed to transmit force from the drive wheel to the saw chain, in particular the connecting links.

Optionally, it is provided that the driving link mounts, in particular the projections of the driving link mounts, have a height in the range from 10% up to and including 50%, in particular 10%, 15%, 20%, 25%, 30%, 35%, 40%, 45%, 50%, of the height of the driving links.

Optionally, it is provided that the link mounts of the first type, in particular the projections of the link mounts of the first type, have a height in the range from 10% up to and including 50%, in particular 10%, 15%, 20%, 25%, 30%, 35%, 40%, 45%, 50%, of the height of the connecting links.

Optionally, it is provided that the link mounts of the second type, in particular the projections of the link mounts of the second type, have a height in the range from 10% up to and including 50%, in particular 10%, 15%, 20%, 25%, 30%, 35%, 40%, 45%, 50%, of the height of the connecting links.

Optionally, it is provided that the driving link mounts project beyond the outer edge, in particular the lower edge, of the respective driving links in the direction of the respective connecting means by a range of 1 mm to 10 mm, in particular 1 mm, 2 mm, 3 mm, 4 mm, 5 mm, 6 mm, 7 mm, 8 mm, 9 mm or 10 mm.

Optionally, it is provided that the driving link mounts project beyond the driving link disc, in particular the outer edge of the driving link disc, by a range of 1 mm to 10 mm, in particular 1 mm, 2 mm, 3 mm, 4 mm, 5 mm, 6 mm, 7 mm, 8 mm, 9 mm or 10 mm.

Optionally, it is provided that the link mounts of the first type project beyond the respective link mounting disc, in particular the outer edge of the respective link mounting disc, by a range of 1 mm to 10 mm, in particular 1 mm, 2 mm, 3 mm, 4 mm, 5 mm, 6 mm, 7 mm, 8 mm, 9 mm or 10 mm.

Optionally, it is provided that the link mounts of the second type project beyond the respective link mounting disc, in particular the outer edge of the respective link mounting disc, by a range of 1 mm to 10 mm, in particular 1 mm, 2 mm, 3 mm, 4 mm, 5 mm, 6 mm, 7 mm, 8 mm, 9 mm or 10 mm.

Optionally, it is provided that the link mounts of the first type project beyond the outer edge, in particular the lower edge, of the respective connecting links in the direction of the respective connecting means by a range of 1 mm to 10 mm, in particular 1 mm, 2 mm, 3 mm, 4 mm, 5 mm, 6 mm, 7 mm, 8 mm, 9 mm or 10 mm.

Optionally, it is provided that the link mounts of the second type project beyond the outer edge, in particular the lower edge, of the respective connecting links in the direction of the respective connecting means by a range of 1 mm to 10 mm, in particular 1 mm, 2 mm, 3 mm, 4 mm, 5 mm, 6 mm, 7 mm, 8 mm, 9 mm or 10 mm.

In particular, the driving link mounts protrude from the driving link disc.

In particular, the link mounts of the first type and/or the link mounts of the second type protrude from the link mounting discs.

Optionally, it is provided that the drive wheel, in particular the driving link disc, the link mounting disc and/or the guide disc, has a diameter in the range from 50 mm up to and including 150 mm, in particular in the range from 100 mm up to and including 120 mm.

Optionally, the driving link disc has a diameter in the range from 100 mm up to and including 120 mm, in particular a diameter of 105 mm, 106 mm, 107 mm, 108 mm, 109 mm or 110 mm.

Optionally, the link mounting disc(s) have a diameter in the range from 100 mm up to and including 120 mm, in particular a diameter of 110 mm, 111 mm, 112 mm, 113 mm, 114 mm or 115 mm.

Optionally, the guide disc(s) have a diameter in the range from 100 mm up to and including 120 mm, in particular a diameter of 110 mm, 111 mm, 112 mm, 113 mm, 114 mm or 115 mm.

Optionally, it is provided that the drive wheel, in particular the driving link disc, the link mounting disc(s) and/or the guide disc(s), has a thickness in the range from 0.5 mm up to and including 10 mm, in particular in the range from 1 mm up to and including 5.0 mm.

Optionally, the driving link disc has a thickness in the range from 1 mm up to and including 4.5 mm, in particular a thickness of 3.5 mm.

Optionally, the link mounting disc(s) have a thickness in the range from 1 mm up to and including 4.5 mm, in particular a thickness of 1.055 mm or 4.25 mm.

Optionally, the guide disc(s) have a thickness in the range of 1 mm up to and including 5.0 mm, in particular a thickness of 5.0 mm.

Optionally, it is provided that the guide disc(s) have the same diameter as the other discs of the drive wheel, in particular the driving link disc and/or the link mounting disc(s).

Optionally, the guide discs are designed in such a way that the guide discs protrude over the driving link disc and/or the link mounting discs or are flush with them.

Optionally, it is provided that the guide discs are designed in such a way that the guide discs protrude beyond or terminate with the link mounting discs, the driving link mounts, the link mounts of the first type and/or the link mounts of the second type.

In particular, the invention relates to a drive wheel which is designed for use in a cutting device according to the invention.

The drive wheel may optionally be designed to transmit force from a drive device to a saw chain.

The drive wheel may have all the features described alone or in any combination.

The drive wheel may have several driving link mounts. In particular, the driving link mounts may be designed such that a part of the respective driving link is in engagement with the respective driving link mount, so that force can be transmitted from the drive wheel to the driving links.

The drive wheel may have several link mounts of the first type for transmitting force from the drive wheel to the connecting links.

The link mounts of the first type of the drive wheel may be designed as projections, in particular as raised teeth.

The link mounts of the first type of drive wheel may engage with the respective connecting links.

The link mounts of the first type are designed to move the connecting links in the running direction of the saw chain so that the saw chain can be driven.

In the cutting device according to the invention, the driving links come into contact with the driving link mounts, the connecting links come into contact with the link mounts of the first type and optionally with the link mounts of the second type when the saw chain is driven, in particular for force transmission.

In particular, it may be provided that the saw chain is in engagement with the driving link mounts, the link mounts of the first type and optionally the link mounts of the second type, in particular simultaneously.

Optionally, it is provided that the drive wheel is designed to avoid and/or reduce the polygon effect.

Further features according to the invention optionally emerge from the claims, the description of the exemplary embodiments, and the figures.

The invention is now further explained on the basis of non-exclusive and/or non-limiting exemplary embodiments.

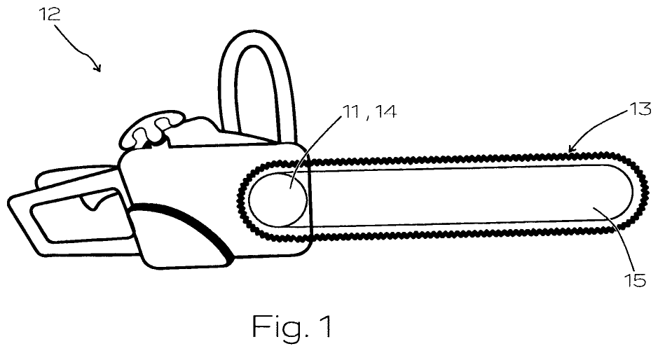

FIG. 1 shows a schematic graphical representation of a first embodiment of the cutting device according to the invention,

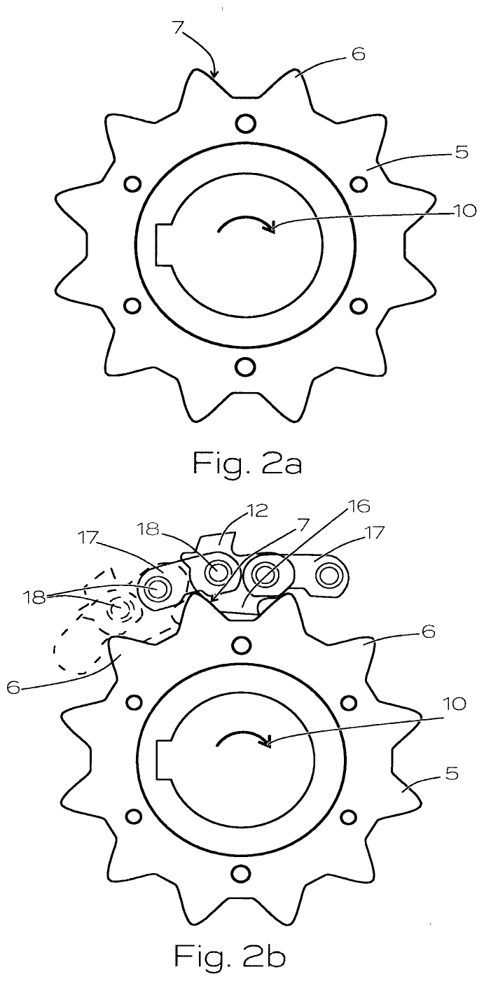

FIGS. 2a and 2b show schematic graphical representations of a first embodiment of the driving link disc of the drive wheel according to the invention,

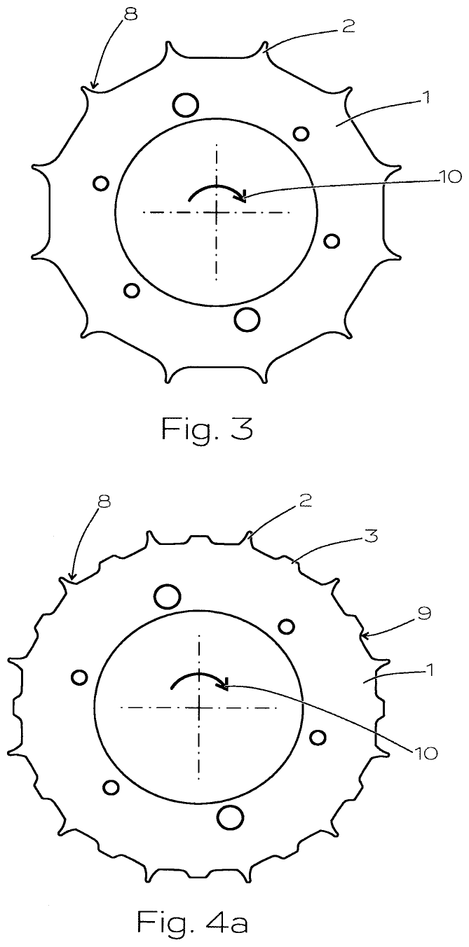

FIG. 3 shows a schematic graphical representation of a first embodiment of a link mounting disc of the drive wheel according to the invention,

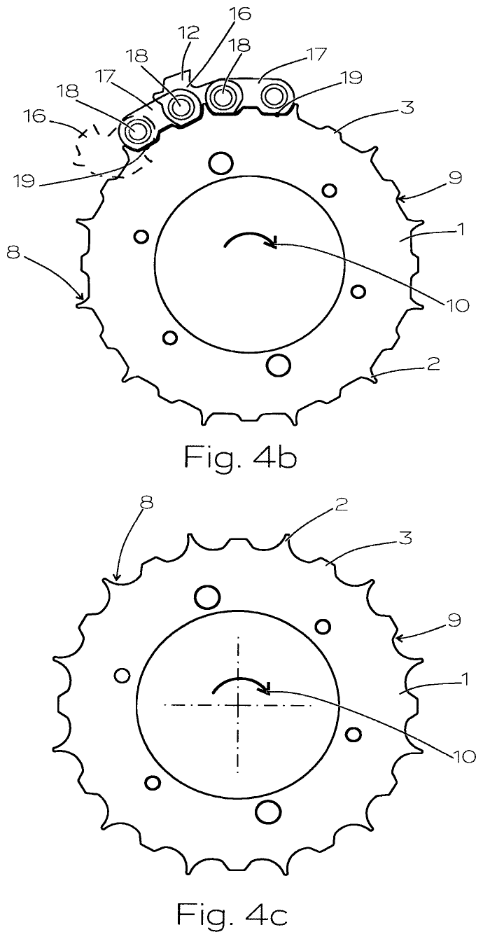

FIGS. 4a, 4b and 4c show a schematic graphical representation of a second and third embodiment of a link mounting disc of the drive wheel according to the invention,

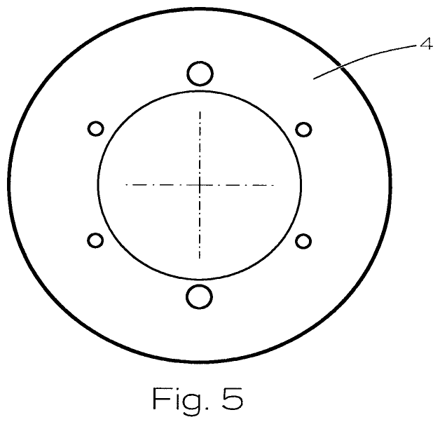

FIG. 5 shows a schematic graphical representation of a first embodiment of a guide disc of the drive wheel according to the invention,

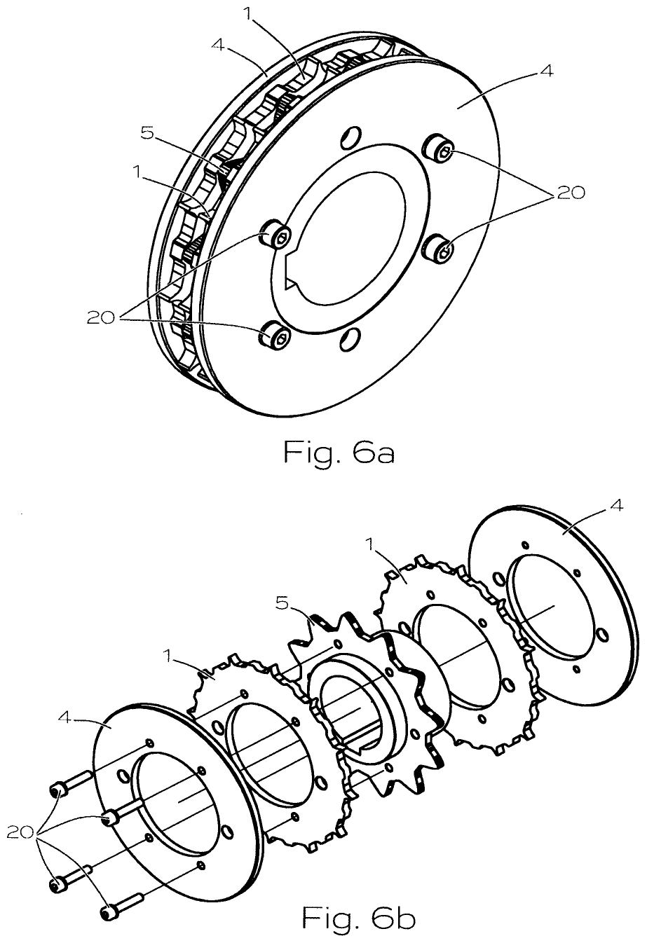

FIGS. 6a and 6b show a schematic graphical three-dimensional representation of a first embodiment of the drive wheel according to the invention,

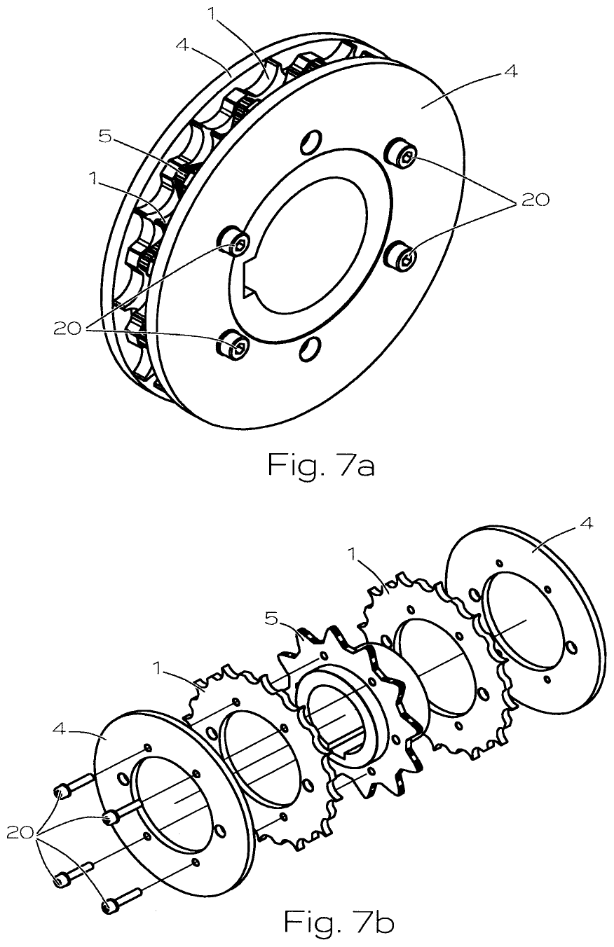

FIGS. 7a and 7b show a schematic graphical three-dimensional representation of a second embodiment of the drive wheel according to the invention,

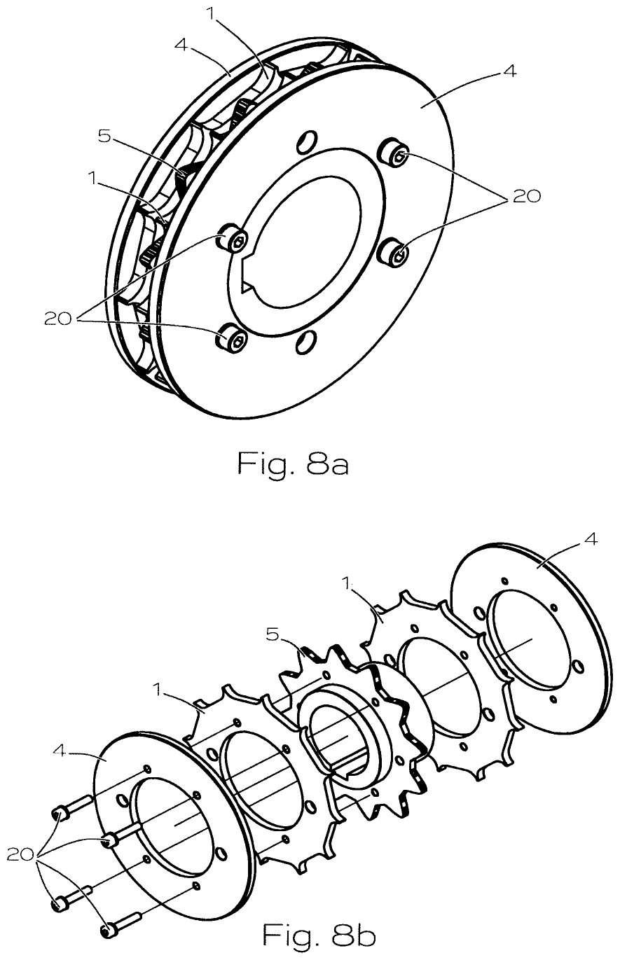

FIGS. 8a and 8b show a schematic graphical three-dimensional representation of a third embodiment of the drive wheel according to the invention,

Unless otherwise indicated, the reference numbers correspond to the following components: link mounting disc 1, link mount of first type 2, link mount of second type 3, guide disc 4, driving link disc 5, driving link mount 6, driving link thrust surface 7, link thrust surface of first type 8, link thrust surface of second type 9, direction of rotation 10, drive wheel 11, cutting device 12, saw chain 13, first deflection point 14, second deflection point 15, driving link 16, connecting link 17, connecting means 18, outer edge 19 and connecting device 20.

FIG. 1 shows a schematic graphical representation of a first embodiment of the cutting device 12 according to the invention in a side view.

The cutting device 12 according to the invention, in particular the chainsaw, comprises a saw chain 13 and a drive wheel 11.

The saw chain 13 comprises driving links 16 and connecting links 17. According to this embodiment, the saw chain 13 is designed as an endless chain.

The connecting links 17 are arranged, in particular on both sides, next to the driving links 16.

The connecting links 17 are connected to the driving links 16 by connecting means 18, in particular rivets.

Cutting devices 12 are provided on the driving links 16 for cutting a material to be cut, in particular for chipping wood or plastic.

The saw chain 13 extends from a first deflection point 14 to a second deflection point 15.

The drive wheel 11 is designed to transmit force to the saw chain 13.

A part of the saw chain 13, in particular at least one driving link 16 and at least one connecting link 17, is in contact with the drive wheel 11.

A part of the saw chain 13, in particular at least one driving link 16 and at least one connecting link 17, is in engagement with the drive wheel 11.

According to this embodiment, the drive wheel 11 has a plurality of driving link mounts 6 and a plurality of link mounts of the first type 2.

FIGS. 2a and 2b show a schematic graphical representation of a first embodiment of the driving link disc 5 of the drive wheel 11 of the cutting device 12 according to the invention in side views. The features of the embodiment according to FIGS. 2a and 2b may preferably correspond to the features of the embodiments according to FIG. 1.

In FIG. 2b, a part of the saw chain 13 is shown for better understanding, which is in engagement with the respective driving link mounts 6 of the driving link disc 5.

The driving link disc 5 with the driving link mounts 6 has a diameter of approximately 106 mm.

The driving link disc 5 has a thickness of approximately 3.5 mm.

The driving link mounts 6 are formed as projections, in particular as raised teeth.

Furthermore, a part of the respective driving link 16 is in engagement with the respective driving link mount 6, so that force can be transmitted from the drive wheel 11 to the driving links 16.

The driving link mounts 6 are provided, in particular evenly distributed, on the circumference of the drive wheel 11, in particular the driving link disc 5.

The driving link mounts 6 are also arranged evenly spaced from one another on the drive wheel 11, in particular the driving link disc 5.

Furthermore, the driving link mounts 6 each have a driving link thrust surface 7. The driving link thrust surface 7 is designed to transmit force to the driving links 16 and thus drive the saw chain 13.

The driving link mounts 6 protrude from the driving link disc 5.

According to this embodiment, the driving link mounts 6 project beyond the driving link disc 5, in particular its outer edge 19, by approximately 10 mm.

FIG. 3 shows a schematic graphical representation of a first embodiment of a link mounting disc 1 of the drive wheel 11 of the cutting device 12 according to the invention in a side view. The features of the embodiment according to FIG. 3 may preferably correspond to the features of the embodiments according to FIGS. 1, 2a and/or 2b.

The link mounting disc 1 with the link mounts of the first type 2 has a diameter of approximately 112 mm.

The link mounting disc 1 has a thickness of approx. 4.25 mm.

The link mounts of the first type 2 are formed as projections, in particular as raised teeth.

The link mounts of the first type 2 are in engagement with the respective connecting links 17.

The link mounts of the first type 2 are designed to transmit force from the drive wheel 11 to the respective connecting links 17. This allows the saw chain 13 to be driven or moved.

According to this embodiment, only the link mounts of the first type 2 are provided on the link mounting disc 1.

During force transmission, the link mounts of the first type 2 are in engagement with a first region, in particular with a peripheral region, of the outer edge 19 of the respective connecting link 17.

According to this embodiment, the link mounts of the first type 2 are provided, in particular evenly distributed, on the circumference of the drive wheel 11, in particular of the link mounting disc 1.

According to this embodiment, the link mounts of the first type 2 are arranged evenly spaced from one another on the drive wheel 11, in particular the link mounting disc 1.

The link mounts of the first type 2 each have a link thrust surface of the first type 8, wherein the link thrust surface of the first type 8 is arranged to transmit force to the respective connecting link 17.

According to this embodiment, the link mounts 2, 3 are arranged protruding from the link mounting disc 1.

The link mounts of the first type 2 project beyond the respective link mounting disc 1, in particular its outer edge 19, by approximately 6 mm.

FIGS. 4a, 4b and 4c show a schematic graphic representation of a second and third embodiment of a link mounting disc 1 of the drive wheel 11 of the cutting device 12 according to the invention in side views. The features of the embodiments according to FIGS. 4a, 4b and 4c may preferably correspond to the features of the embodiments according to FIGS. 1, 2a, 2b and/or 3.

In FIG. 4b, a part of the saw chain 13 is shown for better understanding, which is engaged with the respective link mounts of the first type 2 and with the respective link mounts of the second type 3.

According to this embodiment, several link mounts of the second type 3 are provided on the drive wheel 11, in particular on the link mounting disc 1.

The link mounts of the second type 3 are formed as projections, in particular as raised teeth.

The link mounts of the second type 3 are in engagement with the respective connecting links 17.

Furthermore, the link mounts of the second type 3 are arranged to move the connecting links 17 in the running direction of the saw chain 13, so that the saw chain 13 can be driven.

According to this embodiment, the link mounts of the second type 3 are designed in such a way that they engage with a second region of the outer edge 19 of the respective connecting link 17 during force transmission.

In particular, the link mounts of the second type 3 are designed in such a way that they engage in the centre of the respective connecting link 17 during force transmission.

According to this embodiment, the link mounts of the first type 2 and the link mounts of the second type 3 are provided, in particular evenly distributed, on the circumference of the drive wheel 11, in particular the link mounting disc 1.

In particular, the link mounts of the first type 2 and the link mounts of the second type 3 are arranged evenly spaced apart from one another on the drive wheel 11, in particular the driving link disc 5 and/or the link mounting disc 1.

According to this embodiment, the link mounts of the second type 3 each have a link thrust surface of the second type 9, wherein the link thrust surface of the second type 9 is arranged to transmit force to the respective connecting link 17.

Both the link mounts of the first type 2 and the link mounts of the second type 3 are arranged protruding from the link mounting disc 1.

The link mounts of the first type 2 project beyond the respective link mounting disc 1, in particular its outer edge 19, by approximately 6 mm.

The link mounts of the second type 3 project beyond the respective link mounting disc 1, in particular its outer edge 19, by approximately 2 mm.

FIG. 5 shows a schematic graphical representation of a first embodiment of a guide disc 4 of the drive wheel 11 of the cutting device 12 according to the invention in side views. The features of the embodiments according to FIG. 5 may preferably correspond to the features of the embodiments according to FIGS. 1, 2a, 2b, 3, 4a, 4b and/or 4c.

The guide disc 4 has a diameter of approx. 112 mm.

The guide disc 4 has a thickness of approx. 4.25 mm.

According to this embodiment, the guide discs 4 are designed to guide the saw chain 13, in particular horizontally.

The guide disc 4 has connecting means recesses for guiding the connecting means 18, which are not shown for better visibility.

Furthermore, the connecting means recesses are designed to transmit force from the drive wheel 11 to the saw chain 13, in particular to the connecting means 18.

FIGS. 6a and 6b show a schematic graphical three-dimensional representation of a first embodiment of the drive wheel 11 of the cutting device 12 according to the invention. The features of the embodiments according to FIGS. 6a and 6b may preferably correspond to the features of the embodiments according to FIGS. 1, 2a, 2b, 3, 4a, 4b, 4c and/or 5.

FIG. 6b shows an exploded view of the drive wheel 11 according to the invention.

The drive wheel 11 comprises a driving link disc 5 and two link mounting discs 1, the three discs being arranged concentrically to one another.

The driving link mounts 6 are provided on the centrally arranged disc of the drive wheel 11, in particular the driving link disc 5.

The link mounting discs 1 are arranged on both sides of the driving link disc 5.

Furthermore, the link mounting discs 1 are provided with the link mounts of the first type 2 and the link mounts of the second type 3.

According to this embodiment, the drive wheel 11 also comprises two guide discs 4.

The guide discs 4 are arranged concentrically to the driving link disc 5 and the link mounting discs 1 of the drive wheel 11.

The guide discs 4 are each arranged on the free side of the link mounting discs 1.

The driving link disc 5 according to this embodiment may in particular be designed like the driving link disc 5 of FIG. 2.

The link mounting discs 1 according to this embodiment may in particular be designed like the link mounting discs 1 of FIGS. 4a and/or 4b.

The guide discs 4 according to this embodiment may in particular be designed like the guide discs 4 of FIG. 5.

According to this embodiment, the driving link disc 5 is connected, in particular welded, to the drive device of the cutting device 12.

The other discs of the drive wheel 11 are connected to the driving link disc 5, in particular to the drive device, preferably exclusively, via connecting devices 20, in particular screws.

According to this embodiment, the guide discs 4 are designed in such a way that the guide discs 4 project beyond the driving link mount 6 and the link mount of the first type 2.

According to this embodiment, the guide discs 4 are designed in such a way that the guide discs 4 project beyond the driving link mounts of the second type 3 and the driving link mounts 6 and terminate in particular flush with the link mounts of the first type 2.

FIGS. 7a and 7b show a schematic graphical three-dimensional representation of a second embodiment of the drive wheel 11 of the cutting device 12 according to the invention. The features of the embodiments according to FIGS. 7a and 7b may preferably correspond to the features of the embodiments according to FIGS. 1, 2a, 2b, 3, 4a, 4b, 4c, 5, 6a and/or 6b.

FIG. 7b shows an exploded view of the drive wheel 11 according to the invention.

According to this embodiment, the driving link disc 5 may be designed in particular like the driving link disc 5 of FIG. 2.

According to this embodiment, the link mounting discs 1 may in particular be designed like the link mounting discs 1 of FIG. 4c.

FIGS. 8a and 8b show a schematic graphical three-dimensional representation of a third embodiment of the drive wheel 11 of the cutting device 12 according to the invention. The features of the embodiments according to FIGS. 8a and 8b may preferably correspond to the features of the embodiments according to FIGS. 1, 2a, 2b, 3, 4a, 4b, 4c, 5, 6a, 6b, 7a and/or 7b.

FIG. 8b shows an exploded view of the drive wheel 11 according to the invention.

According to this embodiment, the driving link disc 5 may be designed in particular like the driving link disc 5 of FIG. 2.

According to this embodiment, the link mounting discs 1 may in particular be designed like the link mounting discs 1 of FIG. 3. According to this embodiment, only link mounting discs of the first type 2 are provided on the link mounting discs 1.

This exemplary configuration allows the inventive effects to be achieved.

The scope of protection of the invention is not limited to the embodiments shown, but includes any cutting device 12 and any drive wheel 11 according to the following claims.

1. A cutting device (12), in particular a chainsaw, comprising a saw chain (13) and a drive wheel (11),
wherein the saw chain (13) comprises driving links (16) and connecting links (17),
wherein the connecting links (17) are connected to the driving links (16) by connecting means (18), in particular rivets,
wherein cutting devices (12) for cutting a material to be cut, in particular for chipping wood or plastic, are provided on the driving links (16) and/or connecting links (17),
wherein the drive wheel (11) has a plurality of driving link mounts (6),
wherein a part of the respective driving link (16) is in engagement with the respective driving link mount (6), so that force can be transmitted from the drive wheel (11) to the driving links (16),
characterised
in that the drive wheel (11) has a plurality of link mounts of the first type (2),
in that the link mounts of the first type (2) are formed as projections, in particular as teeth,
in that the link mounts of the first type (2) engage with the respective connecting links (17), in particular in a form-fitting manner,
and in that the link mounts of the first type (2) are designed to transmit force from the drive wheel (11) to the respective connecting links (17).

2. The cutting device (12) according to claim 1, characterised in that the link mounts of the first type (2) are in engagement with a first region, in particular with a peripheral region, of the outer edge (19) of the respective connecting link (17) during force transmission.

3. The cutting device (1) according to claim 1, characterised
in that several link mounts of the second type (3) are provided on the drive wheel (11),
and/or in that the link mounts of the second type (3) are formed as projections, in particular as teeth,
and/or in that the link mounts of the second type (3) engage with the respective connecting links (17), in particular in a form-fitting manner,
and/or in that the link mounts of the second type (3) are designed to move the connecting links (17) in the running direction of the saw chain (13) so that the saw chain (13) can be driven.

4. The cutting device (12) according to claim 1, characterised
in that the link mounts of the second type (3) are arranged on the drive wheel (11) in such a way that they engage with a second region of the outer edge (19) of the respective connecting link (17) during force transmission,
and in that, optionally, the link mounts of the second type (3) are arranged on the drive wheel (11) in such a way that they optionally engage in the centre of the respective connecting link (17) during force transmission.

5. The cutting device (12) according to claim 1, characterised
in that the drive wheel (11) comprises a driving link disc (5) and two link mounting discs (1),
and/or wherein the three discs, in particular the driving link disc (5) and the link mounting discs (1), are arranged concentrically to one another,
and/or wherein the driving link mounts (6) are provided on the centrally arranged disc of the drive wheel (11), in particular the driving link disc (5),
and/or wherein the link mounting discs (1) are arranged, in particular on both sides, on the driving link disc (5),
and/or wherein the link mounts of the first type (2) and optionally the link mounts of the second type (3) are provided on the link mounting discs (1).

6. The cutting device (12) according to claim 1, characterised
in that the drive wheel (11) comprises two guide discs (4),
and/or in that the guide discs (4) are arranged concentrically to the driving link disc (5) and the link mounting discs (1) of the drive wheel (11),
and/or in that the guide discs (4) are designed to guide the saw chain (13), in particular horizontally,
and/or in that the guide discs (4) are arranged on the three discs, in particular on both sides.

7. The cutting device (12) according to claim 6, characterised
in that the guide discs (4) have connecting means recesses for guiding the connecting means (18),
and in that, optionally, the connecting means recesses are formed for transmitting force from the drive wheel (11) to the saw chain (13), in particular to the connecting means (18).

8. The cutting device (12) according to claim 5, characterised
in that the driving link disc (5) is connected, in particular welded, to the drive device of the cutting device (12),
and in that, optionally, the other discs, in particular the link mounting discs (1) and/or the guide discs (4), are connected to the driving link disc (5), in particular to the drive device, preferably exclusively, by means of connecting devices (20), in particular screws.

9. The cutting device (12) according to claim 1, characterised
in that the driving link mounts (6) are provided, in particular evenly distributed, on the circumference of the drive wheel (11), in particular the driving link disc (5),
and/or in that the link mounts of the first type (2) and, if applicable, the link mounts of the second type (3) are provided, in particular evenly distributed, on the circumference of the drive wheel (11), in particular the link mounting discs (1).

10. The cutting device (12) according to claim 1, characterised
in that the driving link mounts (6), the link mounts of the first type (2) and/or the link mounts of the second type (3) are arranged symmetrically on the drive wheel (11), in particular the driving link disc (5) and/or the link mounting discs (1),
and/or in that the driving link mounts (6), the link mounts of the first type (2) and/or the link mounts of the second type (3) are arranged evenly spaced apart from one another on the drive wheel (11), in particular the driving link disc (5) and/or the link mounting discs (1).

11. The cutting device (12) according to claim 1, characterised
in that the driving link mounts (6) each have a driving link thrust surface (7), the driving link thrust surface (7) being designed to transmit force to the driving link (16),
and/or in that the link mounts of the first type (2) each have a link thrust surface of the first type (8), wherein the link thrust surface of the first type (8) is designed to transmit force to the respective connecting link (17).
and/or in that the link mounts of the second type (3) each have a link thrust surface of the second type (9), wherein the link thrust surface of the second type (3) is designed to transmit force to the respective connecting link (17).

12. The cutting device (12) according to claim 1, characterised
in that the driving link mounts (6) have a height in the range from 10% up to and including 50%, in particular 10%, 15%, 20%, 25%, 30%, 35%, 40%, 45%, 50%, of the height of the driving links (16),
and/or in that the link mounts of the first type (2) and, optionally, the link mounts of the second type (3) have a height in the range from 10% up to and including 50%, in particular 10%, 15%, 20%, 25%, 30%, 35%, 40%, 45%, 50%, of the height of the connecting links (17),
and/or in that the driving link mounts (6) project beyond the driving link disc (5), in particular its outer edge (19), by a range of 1 mm to 10 mm, in particular 1 mm, 2 mm, 3 mm, 4 mm, 5 mm, 6 mm, 7 mm, 8 mm, 9 mm or 10 mm,
and/or in that the link mounts of the first type (2) and optionally the link mounts of the second type (3) project beyond the respective link mounting disc (1), in particular its outer edge (19), by a range of 1 mm to 10 mm, in particular 1 mm, 2 mm, 3 mm, 4 mm, 5 mm, 6 mm, 7 mm, 8 mm, 9 mm or 10 mm.

13. The cutting device (12) according to claim 1, characterised
in that the driving link mounts (6) project beyond the outer edge (19), in particular the lower edge, of the respective driving links (16) in the direction of the respective connecting means (17) by a range of 1 mm to 10 mm, in particular 1 mm, 2 mm, 3 mm, 4 mm, 5 mm, 6 mm, 7 mm, 8 mm, 9 mm or 10 mm,
and/or in that the link mounts of the first type (2) and optionally the link mounts of the second type (3) project beyond the outer edge (19), in particular the lower edge, of the respective connecting links (17) in the direction of the respective connecting means (18) by a range of 1 mm to 10 mm, in particular 1 mm, 2 mm, 3 mm, 4 mm, 5 mm, 6 mm, 7 mm, 8 mm, 9 mm or 10 mm.

14. The cutting device (12) according to claim 1, characterised
in that the drive wheel (11), in particular the driving link disc (5), the link mounting disc (1) and/or the guide disc (4), has a diameter in the range from 50 mm up to and including 150 mm, in particular in the range from 100 mm up to and including 120 mm,
and/or in that the drive wheel (11), in particular the driving link disc (5), the link mounting disc (1) and/or the guide disc (4), has a thickness in the range from 0.5 mm up to and including 10 mm, in particular in the range from 1 mm up to and including 5.0 mm,
and/or in that the guide discs (4) have the same diameter as the other discs of the drive wheel (11), in particular the driving link disc (5) and/or the link mounting discs (1),
and/or in that the guide discs (4) are designed in such a way that the guide discs (4) project beyond or terminate with the driving link disc (5), the link mounting discs (1), the driving link mounts (6), the link mounts of the first type (2) and/or the link mounts of the second type (3).

15. A drive wheel (11) adapted for use in a cutting device (12) according to claim 1.
